(19) United States
(12) Patent Application Publication
(10) Pub. No.: US 2006/0014534 A1
(43) Pub. Date: Jan. 19, 2006

(54) System and method for providing UPnP announcements convergence

(75) Inventors: Jose Costa-Requena, Helsinki (FI); Kari Kaarela, Oulu (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 10/894,137

(22) Filed: Jul. 19, 2004

(51) Int. Cl. H04Q 7/20

(52) U.S. Cl. 455/432.1

(57) ABSTRACT

A system and method for updating and/or refreshing service announcements at regular intervals to a limited device within a network. The limited device sends a signal to the other devices in the network, requesting that refreshments and/or updates be provided at certain intervals. During these intervals, the limited device can enter a sleep mode, preserving battery life. At the end of the interval, the limited device exits the sleep mode and accepts any necessary updates and/or refreshments.

### BACKGROUND OF THE INVENTION

The present invention relates generally to the field of terminal architecture in a network. More particularly, the present invention relates to terminal architecture in a network when implementing Universal Plug and Play (UPnP) protocol on limited devices having energy constraints.

Network architectures such as universal plug and play (UPnP) systems have become increasingly popular in recent years. UPnP networks are used to connect and permit communication between a wide variety of electronic devices, including but not limited to desktop and laptop computers, portable and cellular telephones, computer printers, monitors, stereos, personal digital assistants, video game devices and other products. When a device is within the coverage of such a home network, it is capable of communicating with any other devices that are within the network. This allows for the sharing of a wide variety of types of information.

One circumstance in which information is communicated between devices occurs when a new device, such as a portable telephone, first enters a network area. When this “limited” device first enters the network area, it often sends a signal to the other devices on the network, notifying the other device of its presence as well as requesting status information, service announcements and system refreshments and/or updates to the device.

UPnP protocol defines a simple algorithm for searching services on the network. This mechanism involves multicasting a “SEARCH” query to which all devices in the network answer with their services using unicast messages addressed to the device that sent the “SEARCH” message. The response normally occurs with a “NOTIFY” message.

Although effective, this system includes a substantial drawback: after sending the multicast “SEARCH” message, the limited device that sent the message must continue to listen at all times for new service announcements and for the refreshments of those announcements. However, keeping the limited device activated at all times to listen for such messages will drain the device's battery.

Current UPnP specifications include a header (i.e. MX) within the multicast “SEARCH” message for indicating to the other devices that they should send the service announcement within the period indicated in that header. For example, when a device enters the network and sends the “SEARCH” message for receiving the service announcements, the device may include in the MX header the value 100 (e.g. MX=100). In this situation, the other devices in the network know that they have to send their service announcements to the new device within the following 100 seconds using unicast messages. However, there is currently no mechanism for instructing other devices to send the service announcements or service updates periodically. It would therefore be desirable to develop a system and method for instructing devices to send information, such as service announcements, on a regular basis. It would also be desirable to develop such a system where new extension headers are used for the purpose of storing this type of information concerning the power of the respective limited device.

### SUMMARY OF THE INVENTION

The present invention defines a “hand shake” mechanism and power state information between UPnP devices that converges into a periodic schedule for sending service updates and announcements. This hand shake mechanism involves the sending of an instruction from a limited device to other devices in the network, instructing the other devices to transmit new service announcements over regular intervals and informing other devices about the mechanism to wake up the device when it goes into sleeping mode. This system permits the limited device to enter into a “sleep” mode for the period of time between the transmittal of service information but still receive the service information at the respective intervals. Additionally, this system and method eliminates the need for the limited device to have to retransmit a “search” message every time it is activated from a sleep mode. Furthermore, this system also allows for the limited device to receive updates while also reducing battery drain by scheduling the times at which the limited device needs to exit the sleep mode. This method allows the limited devices to inform other devices in the network that they are entering into a sleeping period.

### BRIEF DESCRIPTION OF THE DRAWINGS

FIG. 1 is a representation of a limited device entering a network according to one embodiment of the invention, wherein the limited device sends instructions for other devices in the network to transmit service announcements as well as to transmit updates and/or refreshments to the service announcements at regular intervals;

FIG. 2 is a representation of the network of FIG. 1, wherein the limited device exits its “sleep” mode at a designated interval in order to accept updates and/or refreshments to service announcements from other devices in the network; and

FIG. 3 is a flow chart showing process of devices providing regular updates and/or refreshments to the limited device.

### DETAILED DESCRIPTION OF THE PREFERRED EMBODIMENTS

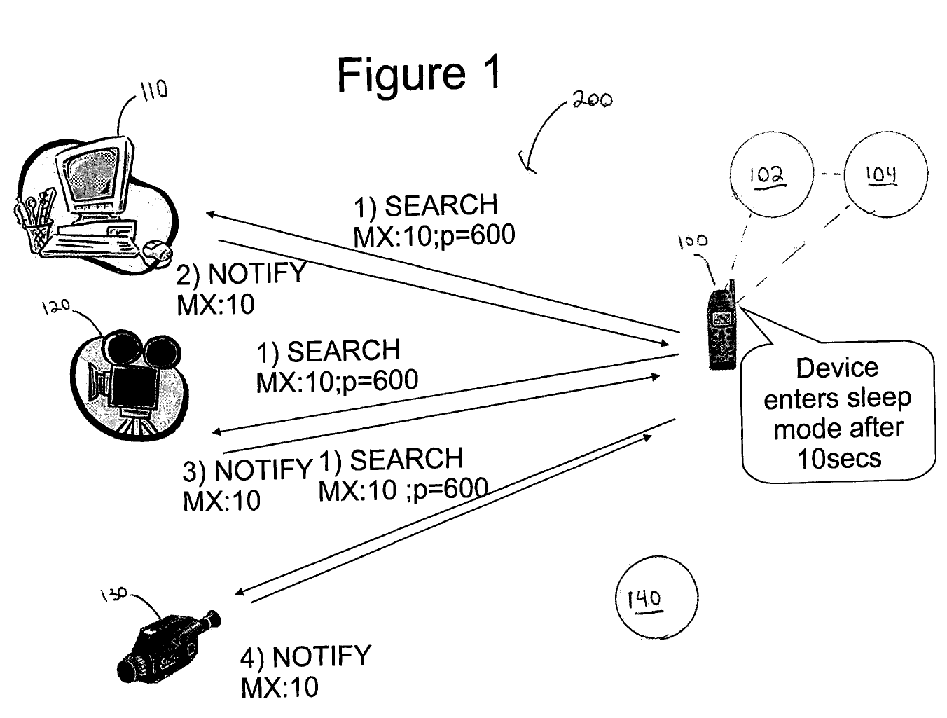

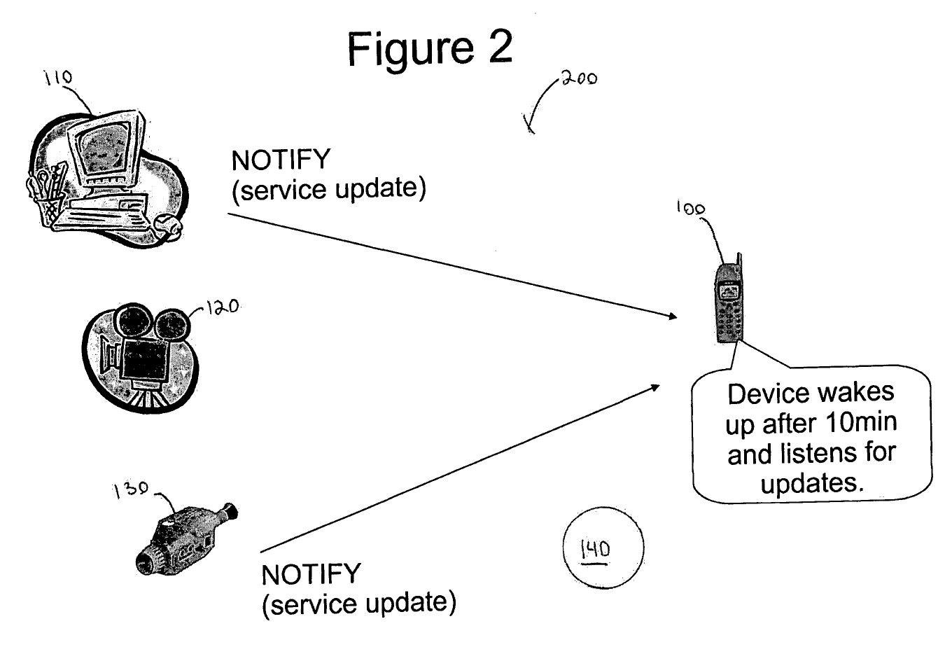

The present invention involves the transmission of a signal from a limited device to other devices on a network for the purpose of instructing the other devices to send service announcements, refreshments and/or updates on a periodic basis. According to one embodiment of the invention and as shown in FIGS. 1 and 2, implementation of this system involves the addition of a new media parameter on an existing MX header. For example, when a signal is sent with a conventional MX header reading “MX=10”, other devices in the network understand the instruction to require the transmission of any new service announcements within ten seconds using unicast messages. According to one embodiment of the present invention, this header can modified to include an additional value regarding the intervals at which subsequent service announcement should be sent.

For example and as shown in FIGS. 1 and 2, when a limited device 100 enters a network, shown generally at 200, it sends the “SEARCH” message for receiving service announcements. In the embodiment of the invention shown in FIGS. 1 and 2, the limited device 100 comprises a cellular telephone. However, the limited device 100 can be virtually any electronic device that interacts with a network. The limited device 100 includes a memory 102 and a processor 104 for processing programs stored in the memory 102. The limited device 100 includes in the MX header a value “MX=10;p=600.” This message is received by other devices in the network, such as a personal computer 110, a projection device 120, and a camcorder 130. A wide variety of other devices, including but not limited to personal digital assistants (PDA's), computer printers, scanners, monitors, stereos, televisions, telephones, pagers, could also be included in the network.

As is the case using conventional headers, the various devices understand the “MX=10” section of the header to require that any new service announcements be transmitted, in the form of the “NOTIFY” message depicted in FIG. 1, to the limited device 100 within ten seconds. However and in this particular embodiment of the invention, the header also includes a value of “p=600.” or this value can be included in a separate header specifically defined for this purpose. This value refers to a 600 second interval at which times service announcement refreshments or updates should be sent. During the time between updates and/or refreshements, the limited device 100 is free to enter the “sleep” mode, conserving its battery. At the end of the 600 second (or ten minute) interval, the limited device 100 wakes up and exits the “sleep” mode in order to accept the next series of updates and/or refreshments, preferably over the same ten second interval that the limited device 100 originally requested. As shown in FIG. 2, after the limited device 100 is awake, new “NOTIFY” signals are sent from every device where an update or refreshment is needed within the aforementioned ten second interval.

During such a 600 second interval, in many situations other devices will have entered the network 200, and it likely that these additional devices will have announced their services while the device was sleeping. Therefore and according to one embodiment of the invention, if there is sufficient battery power available when the limited device 100 is activated from the “sleep” mode, the limited device 100 will send a new “SEARCH” message using the same procedure as identified above (e.g. MX=10;p=600). In this situation, however, the message will include an existing header named CONFIGID and BOOTID in order to inform the existing devices that the limited device 100 already has service information from the previous period for those devices which were already in the network 200 and, unless the service information has changed, these devices do not need to send the service information again. Under this system, only the new services available in the network 200 and the new services that entered the network 200 will inform the limited device 100 of the services, and therefore all of the devices will converge to the sleep period of the limited device.

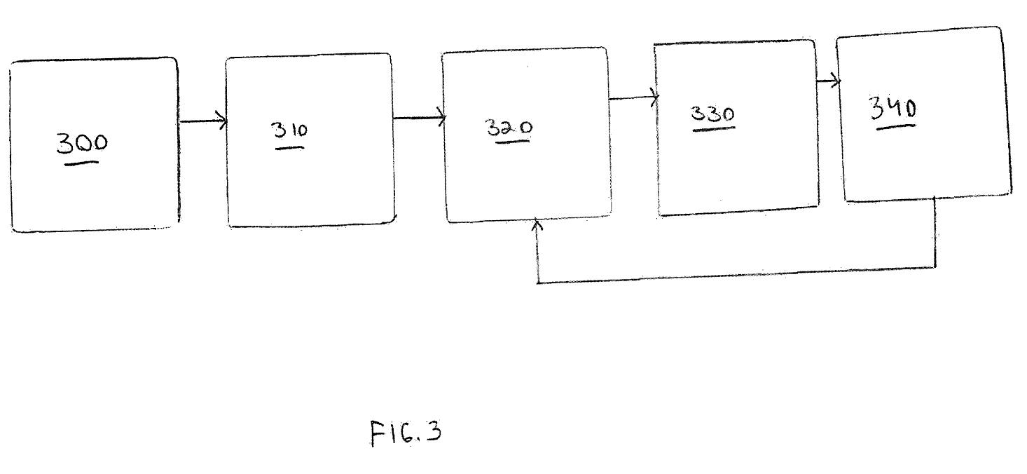

FIG. 3 is a flow chart showing the interaction between the limited device 100 of FIGS. 1 and 2 and one representative device already part of the network. At step 300 in FIG. 3, the limited device 100 transmits a “SEARCH” MX=10;p=600 signal or using a new header such as SLEEP=600. At step 310, the other device responds by transmitting a “NOTIFY” signal within ten seconds, providing the requested service announcement. At 320 and at the end of the ten second period, the limited device 100 enters the “sleep” mode. At step 330 and at the end of a 600 second interval from the initial “Search” signal from the limited device 100, the limited device 100 awakens. At step 340, which corresponds to the awakening of the limited device 100, the other device sends a new “NOTIFY” signal and any necessary refreshments and/or updates to the limited device 100, if such an update and/or refreshment is required. This signal is also sent over a ten second interval. This process is then continuously repeated so that the limited device 100 is constantly updated while also preserving battery power.

Under the system of the present invention, the limited device 100 does not have to send out the “SEARCH” message every times wakes up from the “sleep” mode, since the other devices proactively will send their updates since they received the proposed refresh period information on the first “SEARCH” message. However, the limited device 100 may send new “SEARCH” messages, according to one embodiment of the invention, depending on battery status. Sending new “SEARCH” messages will aid the limited device 100 in having more accurate information since some service announcements may be lost while the device was sleeping.

In an alternative embodiment of the invention, the network can include an intermediate proxy, represented 140 in FIGS. 1 and 2, that can cache service announcements that are transmitted when the limited device 100 is in a “sleep” mode and send them to the limited device 100 when the limited device 100 exits the sleep mode. The limited device 100 before going to sleep will inform the proxy the sleeping period (e.g. with the extension in MX header or using a new header specified for this purpose). The limited device 100 will indicate to the proxy and other devices in the network 200 the mechanism to wake the device if it does not respond after the indicated sleeping period. The “wake up” information will be included together with the sleep period (e.g. either with an extension to MX header or using a new header specified for this purpose).

In addition to the above, there are a variety of other mechanisms that could be used to send an instruction for devices to transmit refreshments and/or updates to the limited device at regular intervals. For example, instead of modifying an existing header, the limited device 100 could send an entirely new header that is directed specifically to setting and/or modifying the intervals at which service information should be sent. In one particular embodiment of the invention, updates and/or refreshment intervals are established by including the addition of an extension header where the power information of the limited device can be stored. For example but without limitation, a SSDP header such as “powerstatus.upnp.org” can be used to save information concerning the power status of the limited device (with sample values being “Active” and “Sleep”), while an extension header such as “sleeptimeout.upnp.org” could be used to preserve information concerning when the limited device is in a sleep mode. Other systems using similar types of computer code could also be used.

As discussed above, the system and method of the present invention can also be implemented on an intermediary UPnP device or proxy. However, it is preferable to have the “handshake” agreed directly between the limited device 100 and the other UPnP end devices.

While preferred embodiments have been shown and described herein, it should be understood that changes and modifications can be made to the invention without departing from the invention in its broader aspects. Various features of the invention are defined in the following claims

What is claimed is:

1. A method of updating service information on a limited device within a network, comprising the steps of:
transmitting a first instruction from the limited device to a plurality of secondary devices, the first instruction including a first designated time interval and wake up mechanism;
having the plurality of secondary devices accept the first instruction; and
upon the expiration of the first designated time interval, transmitting an update from the plurality of secondary devices to the limited device if such an update exists.

2. The method of claim 1, wherein the first instruction includes a request for information from the plurality of secondary devices within a second designated time interval.

3. The method of claim 2, further comprising the step of having the limited device enter a sleep mode at the end of the second designated time interval, and wherein the limited device exits the sleep mode at the end of the first designated time interval.

4. The method of claim 3, further comprising the step of, upon exiting the sleep mode, transmitting a second instruction from the limited device to the plurality of secondary devices, the second instruction including a request for information from the plurality of secondary devices within a third designated time interval.

5. The method of claim 4, wherein the third designated time interval is equal to the second designated time interval.

6. The method of claim 1, further comprising the steps of:
in the event that an update is transmitted to the limited device while the limited device is in the sleep mode, storing the update on an intermediate proxy; and
upon the limited device exiting the sleep mode, transmitting the update from the intermediate proxy to the limited device.

7. The method of claim 1, further comprising the step of transmitting from the limited device to the plurality of secondary devices a second instruction separate from the first instruction requesting information from the plurality of secondary devices within a second designated time interval.

8. The method of claim 1, wherein the wake up mechanism instructs the plurality of secondary devices to wake the limited device if the limited device does not respond to the plurality of the secondary devices after the update is transmitted.

9. A computer software program for updating service information on a limited device within a network, comprising:
computer code for transmitting a first instruction from the limited device to a plurality of secondary devices, the first instruction including a first designated time interval;
computer code for having the plurality of secondary devices accept the first instruction; and
computer code transmitting an update for at the first designated time interval from the plurality of secondary devices to the limited device if such an update exists.

10. The computer software program of claim 9, wherein the first instruction includes a request for information from the plurality of secondary devices within a second designated time interval.

11. The computer software program of claim 10, further comprising computer code for having the limited device enter a sleep mode at the end of the second designated time interval and for having the limited device exit the sleep mode at the end of the first designated time interval.

12. The computer software program of claim 11, further comprising computer code for, upon exiting the sleep mode, transmitting a second instruction from the limited device to the plurality of secondary devices, the second instruction including a request for information from the plurality of secondary devices within a third designated time interval.

13. The computer software program of claim 12, wherein the third designated time interval is equal to the second designated time interval.

14. The computer software program of claim 13, further comprising:
Computer code for storing an update on an intermediate proxy in the event that an update is transmitted to the limited device while the limited device is in the sleep mode; and
Computer code for transmitting the update from the intermediate proxy to the limited device upon the limited device exiting the sleep mode.

15. The computer software program of claim 9, further comprising computer code for sending from the limited device to the plurality of secondary devices a second instruction separate from the first instruction requesting information from the plurality of secondary devices within a second designated time interval.

16. The computer software program of claim 9, further comprising computer code for having the limited device instruct the plurality of secondary devices to wake the limited device if the limited device does not respond to the plurality of the secondary devices after the update is transmitted.

17. A system for updating service information on a limited device within a network, comprising:
a limited device having communication capabilities; and
a plurality of secondary devices in communication with the limited device;
wherein, in response to the transmittal of a first instruction from the limited device to the plurality of secondary devices, the first instruction including a first designated time interval; the plurality of secondary devices transmit updates to the limited devices at intervals corresponding to the first designated time interval.

18. The system of claim 17, wherein the first instruction includes a request for information from the plurality of secondary devices within a second designated time interval.

19. The system of claim 18, wherein the limited device enters a sleep mode at the end of the second designated time interval, and wherein the limited device exits the sleep mode at the end of the first designated time interval.

20. The system of claim 19, wherein upon exiting the sleep mode, a second instruction is transmitted from the limited device to the plurality of secondary devices, the second instruction including a request for information from the plurality of secondary devices within a third designated time interval.

21. The system of claim 20, wherein the third designated time interval is equal to the second designated time interval

22. The system of claim 21, further comprising an intermediate proxy, wherein in the event that an update is transmitted to the limited device while the limited device is in the sleep mode, the update on the intermediate proxy and then transmitted to the limited device when the limited device exits the sleep mode.

23. The system of claim 17, wherein the limited device also transmits a second instruction separate from the first instruction requesting information from the plurality of secondary devices within a second designated time interval.

24. The system of claim 17, wherein the limited device also transmits a wake up instruction to the plurality of the secondary devices, instructing the plurality of secondary devices to wake the limited device if the limited device does not respond to the plurality of the secondary devices after updates are transmitted.

25. A limited electronic device, comprising:
a body;
a processor operatively connected to the body; and
a memory operatively connected to the processor, the memory including a computer software program stored therein for actuation by the processor and including computer code for transmitting a first instruction from the limited device to a plurality of secondary devices, the first instruction including a first designated time interval and requesting that the plurality of secondary devices transmit an update for the limited electronic device at the first designated time interval if such an update exists,
wherein the limited electronic device enters an active mode at the first designated time interval to accept the update from each of the plurality of secondary devices.

26. The limited electronic device of claim 25, wherein the first instruction includes a request for information from the plurality of secondary devices within a second designated time interval.

27. The limited electronic device of claim 26, wherein the limited device enters a sleep mode at the end of the second designated time interval

28. The limited electronic device of claim 27, wherein the computer software program includes computer code for upon exiting the sleep mode, transmitting a second instruction from the limited device to the plurality of secondary devices, the second instruction including a request for information from the plurality of secondary devices within a third designated time interval.

29. The limited electronic device of claim 28, wherein the third designated time interval is equal to the second designated time interval.

30. The limited electronic device of claim 25, wherein the limited electronic device also transmits a wake up instruction to the plurality of the secondary devices, instructing the plurality of secondary devices to wake the limited device if the limited device does not respond to the plurality of the secondary devices after the update is transmitted.
